(19) United States
(12) Patent Application Publication
(10) Pub. No.: US 2007/0167531 A1
(43) Pub. Date: Jul. 19, 2007

(54) Natural particulate carbonate

(76) Inventors: David John Preston, Cornwall (GB); Erik Johannes Petrus Van Dijnen, Weert (NL); Anthony Hales Asbridge, Cornwall (GB); Deborah Susan Thrale, Cornwall (GB); Edward J. Sare, Macon, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/588,440

(22) PCT Filed: Feb. 3, 2005
(86) PCT No.: PCT/GB05/00361

§ 371 Date: Jan. 25, 2007

(30) Foreign Application Priority Data
Feb. 5, 2004 (GB) 0402597.9
Oct. 7, 2004 (GB) 0422297.2

(51) Int. Cl. B01F 3/12

(52) U.S. Cl. 516/88

(57) ABSTRACT

There is provided a natural alkaline earth metal carbonate having a d₅₀ of about 0.5 μm or less and a moisture pick up of less than about 0.2 wt %, as well as a process for making the particulate carbonate by grinding. The carbonate may be used in polymer compositions.

This invention relates to a natural, particulate alkaline earth metal carbonate having desirable characteristics which may be used as a filler in moisture-curing sealants, mastics, adhesives and the like.

### BACKGROUND OF THE INVENTION

The use of finely ground natural calcium carbonate as a filler in moisture curing polymers is known. For example, WO-A-00/20336 discloses an ultra-finely ground natural calcium carbonate having a BET nitrogen surface area of 14 to 30 m²/g for use in such sealant and similar applications. The use of such fillers is stated to provide the sealant composition with desirable Theological and mechanical properties.

A problem with such ultra-finely ground calcium carbonates is that, after drying, and coating with a hydrophobic agent which renders the surfaces of the particles hydrophobic, they are apt to pick up moisture from their surroundings and to retain this moisture adsorbed to the surfaces of the particle and trapped within the hydrophobic coating. Such moisture is highly undesirable since it must be removed prior to use or in situ, or reduced to a very low level before the filler may be incorporated in a moisture-curing polymer composition. The presence of excessive amounts of moisture can dramatically reduce the shelf life of the polymer composition. The presence of moisture in the particulate carbonate can also be detrimental where it is to be used as a filler in two component polyurethane systems; in particular the isocyanate “B” component may cure in the presence of such moisture and therefore lead to non-effective polymerization when mixed with the “A” component. Foaming may also be a problem.

U.S. Pat. No. 5,533,678 discloses an ultra-fine ground calcium carbonate having a BET surface area greater than 20 m²/g for use in polymers. There is no mention of the significance of the moisture content of the fillers in this reference.

U.S. Pat. No. 6,569,527 describes a ground calcium carbonate filler for breathable film, the filler particles having a mean particle size of from 0.5 to 1.0 μm and a BET nitrogen surface area of 3-6 m²/g. The ground material has a low moisture content and is stated not to be susceptible to substantial moisture pick up. The absence of moisture is important in this reference to avoid the formation of steam in the production of breathable film when the polymer is in the plastic melt phase, which can lead to voids in the film.

### SUMMARY OF THE INVENTION

The present inventors have found that a dried natural alkaline earth metal carbonate, preferably a ground calcium carbonate, in particulate form having a d₅₀ (as defined herein) of 0.5 μm or less and a moisture pick up (as defined herein) of less than 0.2 wt %, optionally coated with a hydrophobising surface treatment agent, may be used with advantage as a filler in a moisture-curing polymer composition, or where moisture is otherwise detrimental to the curing process as in two part polyurethane systems. In an embodiment of this aspect of the invention, the carbonate has a surface area of less than 14 m²/g as measured by the BET nitrogen method. The dried, optionally coated, carbonate provides the composition with desirable rheological and mechanical properties, yet additionally provides advantages through controlled moisture content and moisture pick up characteristics.

Thus, in a first aspect of the present invention, there is provided a dried natural alkaline earth metal carbonate in particulate form having a d₅₀ of 0.5 μm or less and a moisture pick up (as herein defined) of less than 0.2 wt %. In an embodiment, the carbonate has a surface area of less than 14 m²/g as measured by the BET nitrogen method,. Typically, the carbonate of this aspect of the invention is dried to a low moisture content, for example below 0.3 wt %, preferably below 0.25 wt % moisture, and treated with a hydrophobising agent. The carbonate of this aspect of the present invention has a low moisture pick up and thus is suitable for use as a filler in moisture-curing polymer compositions, and other polymer systems where moisture is detrimental to the polymerization process.

The present invention, in a second aspect, relates to a polymer composition comprising a moisture-curable polymer resin and a natural carbonate according to the first aspect of the present application. Such polymer compositions may be, for example, a sealant, a mastic, a coating, an adhesive, a plastisol or a rubber. The invention also relates to a cured element, such as a seal element, obtained by curing said polymer composition.

The carbonate may comprise a carbonate obtained from a natural mineral source and processed by refining and treatment processes including grinding to obtain a suitable particle size distribution. In order to satisfy the requirement that the natural carbonate of the present invention has a low surface moisture content its particles may be essentially free of hygroscopic or hydrophilic chemicals. Thus, the carbonate may be obtained by a grinding process carried out either in a dry state in the absence of added hygroscopic or hydrophilic chemicals or in a wet state in an aqueous medium in the absence of dispersant, or with any dispersant employed being minimised and/or subsequently removed from the ground carbonate in a known manner. Wet ground material is subsequently dried to an extent such that the particulate material has and maintains a surface moisture content not greater than about 0.3 wt %, preferably not greater than about 0.25 wt %, based on the dry weight of the carbonate.

After drying, the particles of the carbonate may be treated (coated) with one of the aliphatic carboxylic acid hydrophobising surface treatment agents conventionally employed to coat carbonates. However, it is desirable to treat the material with the surface treatment agent in a manner in which the amount of surface moisture when the surface treatment agent is added and which therefore can become entrapped is minimised and that a significant surface moisture is not introduced to the particulate material during treating, for example as described later. Thus, after the coating stage, the surface moisture content of the carbonate should be below about 0.3 wt %, preferably below 0.25 wt %, based on the dry weight of the carbonate.

### DESCRIPTION OF THE DRAWINGS

FIG. 1 is a comparison of the viscosity characteristics of a SPUR sealant composition made using a natural calcium carbonate of the invention with a similar composition formulated with a commercially available fine PCC.

FIG. 2 is a comparison of the viscosity characteristics of an MS sealant composition made using a natural calcium carbonate of the invention with a similar composition formulated with a commercially available fine PCC.

### DETAILED DESCRIPTION OF THE INVENTION

As previously stated, the present invention pertains to a fine, natural alkaline earth metal carbonate, most preferably calcium carbonate, having a d₅₀ of 0.5 μm or less and a moisture pick up of less than 0.2 wt %. Typically, the natural carbonate material is dried and is coated with a hydrophobic agent, the drying and coating steps being carried out such that the surface moisture content of the coated carbonate is 0.25 wt % or less.

The surface moisture content of the carbonate is determined herein by measuring the loss of weight after drying the carbonate in an oven at 110° C. to constant weight (that is dried to dryness at 110° C.).

The natural carbonate of the invention is not susceptible to substantial moisture pick up, by which is meant that when the carbonate is dried to dryness (at 110° C.) and is then exposed to an atmosphere of 80% relative humidity for 7 days at a temperature of 20° C., the amount of moisture adsorbed is less than 0.2 wt %.

The alkaline earth metal carbonate may be selected from a natural source of a calcium carbonate, magnesium carbonate, calcium magnesium carbonate or barium carbonate. Such natural sources are for example marble, chalk, limestone or dolomite, although marble is the preferred natural source of calcium carbonate since it is not normally associated with surface impurities which may affect the moisture retaining characteristics of the ground material. Desirably, at least 95%, preferably at least 99%, by weight of the inorganic particulate material comprises alkaline earth metal carbonate although minor additions of other mineral additives, e.g. one or more of kaolin, calcined kaolin, wollastonite, bauxite, talc or mica, could also be present together with the carbonate. At least 95% to 99% by weight may be calcium carbonate which may be obtained in a well known way by processing naturally occurring calcium carbonate obtained from a mineral source.

The carbonate of the present invention may have a d₅₀ of about 0.4 μm or less. Further, the carbonate may have a d₅₀ of at least about 0.2 μm. The d₅₀ is for example about 0.4 μm. In one embodiment, the BET nitrogen surface area is up to about 14 m²/g. The BET nitrogen surface area may be at least about 10 m²/g, and in one embodiment is about 12 m²/g.

As used herein, the d₅₀ is the particle size value less than which there are 50% by weight of the particles.

All particle size values as specified herein are measured by the well known standard method employed in the art of sedimentation of the particles in a fully dispersed state in an aqueous medium using a SEDIGRAPH 5100 machine as supplied by Micromeritics Corporation, USA.

The surface area of the alkaline earth metal carbonate is measured using the standard BET nitrogen method as set forth in ISO 9277:1995

In the process for making the fine natural carbonate of the present invention, natural mineral source of the carbonate may have been processed e.g. by known purification, comminution and particle size classification procedures to have a suitable form prior to use to form the carbonate of the present invention. However, following such processing the amount of hygroscopic or hydrophilic additives present is desirably minimised, as described earlier, e.g. by removing any such additives used by a washing process.

Use of surface treatment agents, which, when added to the dry natural carbonate, facilitate dispersion of the inorganic particulate material in hydrophobic polymeric material are well known. Suitable surface treatment agents are known to include aliphatic carboxylic acids having from 10 to 24 carbon atoms in their chain, e.g. stearic acid, palmitic acid, montanic acid, capric acid, lauric acid, myristic acid, isostearic acid and cerotic acid and mixtures thereof.

Procedures are well known to those skilled in the art to produce carbonate products. The production route employed for producing the carbonate may be adapted from these known methods in order to produce the novel carbonate of the present invention having the particle size characteristics noted above and which is essentially free of hygroscopic and hydrophilic chemicals, especially when treated with the hydrophobising surface treatment agent.

The route selected may involve comminution of the starting carbonate, e.g. calciurn carbonate, by wet grinding. Any dispersant employed is preferably minimised or removed, as described later.

Alternatively, grinding may be carried out by a known dry grinding process.

The wet processing of the carbonate, where employed, may be done either by autogenous grinding or by ball milling and/or by stirred media grinding. In autogenous grinding, the particles of the carbonate ore itself act as the grinding media. The feed to the autogenous grinders is the various quarry run ore. Stirred media grinding uses hard, e.g. ceramic or graded sand, media usually having particles larger than the particles to be ground. Usually stirred media grinding starts with a finer feed from a classification step.

Where a wet grinding process is employed to produce the carbonate, the amount of water soluble hydrophilic dispersant remaining following grinding is preferably not greater than 0.05% by dry weight of carbonate. An anionic water soluble dispersant, such as sodium polyacrylate, generally used in a conventional high solids wet grinding or dry grinding process has an undesirable effect on-the ability to dry carbonates and once dried, to maintain that dry state. Such a dispersant is hygroscopic, i.e. attracts moisture, and as it is water soluble makes elimination of surface water difficult. However, residual amounts of other, less hydrophilic dispersants may be present in greater amounts.

Desirably, the amount of dispersant or other hydrophilic chemical on the carbonate is not greater than 0.05 wt % based on the dry weight of the carbonate.

The wet processed carbonate may be washed and dewatered in a known manner, eg, by flocculation, filtration or forced evaporation, prior to drying. A polyelectrolyte might be added in small quantities where it is to be used to flocculate the mineral for ease of dewatering, but the amount of such polyelectrolyte preferably is not greater than 0.05 wt % based on the dry weight of carbonate.

Following grinding, the carbonate may be dried by removing water to leave not more than about 0.3 wt %, preferably not more than about 0.25 wt % surface moisture content associated with the material. This drying procedure may be carried out in a single step or in at least two steps to reduce the surface moisture content thereof to 0.25 wt % or less. Where the carbonate is to be surface coated with a hydrophobising surface treatment agent and a second heating step is used, the second heating step may be applied before and/or during the surface treatment step.

The carbonate may be further dried in the second heating step prior to or during a surface treatment of the carbonate to the extent that the adsorbed moisture content thereof is preferably not greater than about 0.25%, preferably not greater than 0.2%, by weight based on the dry weight of the carbonate.

In any event, the moisture content of the carbonate particles is preferably at most 0.3 wt %, more preferably less than 0.25 wt %, desirably at most 0.2 wt %, at the point the particles are contacted by a surface treatment agent, i.e. the hydrophobising surface treatment agent comprising an aliphatic carboxylic acid, for surface coating thereof.

The surface treatment of the carbonate may be carried out in a dry atmosphere containing a surface treatment agent as a liquid (e.g. as droplets) in a vessel heated indirectly, e.g. by a heating jacket, e.g. containing a heating fluid, e.g. heating oil, as described for example in WO-A-99/28050 (the content of which is herein incorporated by reference). The temperature of the atmosphere in the vessel may be varied and controlled so that a selected atmosphere reaction temperature may be chosen and monitored. The vessel may comprise an elongated heated cylindrical structure. Desirably, the required temperature is maintained throughout the region where the surface treatment agent is applied and exits from that region at about 80° C., desirably about 120° C., or more, e.g. 150° C. or more. It is theorised that attaining the specified low adsorbed moisture content can be attained on the particulate carbonate surface using indirect heating in this way since the carbonate being indirectly heated is not exposed to any combustion by-products from a heating furnace, such as water, which would be the instance if a direct heating system were used. A direct heating system generally involves the use of a vessel heated with flue gases which creates an atmosphere of gases including water vapours which can add to the moisture content of the surface of the carbonate in the vessel. Most conventional natural calcium carbonates are heated and surface treated through this direct heating system described hereinbefore. As described earlier, a direct heating system can be employed in the first step to remove most of the surface moisture, e.g. to a level of not greater than about 0.3%, based on the dry weight of the carbonate, and, thereafter, in the second step use of an indirect heating system is preferably used to avoid the introduction of moisture by the heating step.

The average temperature at which the carbonate is treated with the surface treatment agent may desirably be a temperature in the range 80° C. to 300° C., especially 120° C. to 180° C. with, for example, a residence time of the carbonate in the vessel being greater than 2 seconds. The residence time may, for example, range from about 50 to about 1000 seconds, e.g. 50 seconds to 500 seconds.

Preferably, the surface treatment agent comprises stearic acid or a mixture of fatty acids containing stearic acid, e.g. technical grade stearic acid which typically consists of about 65% by weight stearic acid and about 35% by weight palmitic acid. Other unsaturated fatty acids which may be used to produce carbonates in accordance with the invention may be selected from the group consisting of capric acid, lauric acid, montanic acid, myristic acid, isostearic acid and cerotic acid and mixtures of two or more of these acids and stearic acid and/or graded stearic acids.

The surface treatment agent preferably is a hydrophobising agent which becomes chemisorbed onto the carbonate particles in order to facilitate dispersion of the carbonate in the polymeric composition. For example, stearic acid reacts with calcium carbonate to form a chernisorbed coating of calcium stearate thereon. Such a coating gives superior properties to calcium stearate pre-formed as a compound and typically deposited on the carbonate. In that a main objective of the invention is to reduce the moisture content on the surface of the carbonate, thereby to reduce and maintain the moisture content in the system during the manufacturing process of compositions and products therefrom, it can be appreciated that the presence of a hydrophilic agent is highly undesirable and that only very minute traces (i.e. not greater than 0.05% by weight) of a hydrophilic component are tolerable on the carbonate to be treated with the surface treatment agent.

Desirably, as described in WO-A-99/28050, the amount of surface treatment agent which is present in the heated atmosphere in which the carbonate is to be contacted by and treated with the agent is not substantially greater than the maximum theoretical amount of the agent which can become bonded by chemisorption to the carbonate. This maximum theoretical amount is dependent on the surface area of the particles of the carbonate. The theoretical surface coverage S by the surface treatment agent is given by the equation:
S=MₐNAₐ (1)

where Mₐ is the number of moles of the surface treatment agent present, Aₐ is the surface area occupied by 1 molecule of the surface treatment agent, and N is Avagadro's number. Using Equation (3), it can be shown for example that 1 g of technical grade stearic acid (about 65% by weight stearic acid and about 35% by weight palmitic acid) covers about 460 m² of the surface of a carbonate. Thus, for a particulate material having a surface area of about 12 m²/g, as measured by the BET nitrogen absorption method, about 0.03 g of surface treatment agent is required to give complete coverage of the surface area of each 1 g of carbonate.

Thus, the required theoretical maximum concentration of the surface treatment agent for a calcium carbonate particulate material having a surface area of 12 m²/g is about 3.0% based on the weight of the particulate material to be treated. In practice, the amount of surface treatment agent which becomes bonded to (i.e. chemisorbed onto) the particulate material is less than the theoretical maximum, although by carrying out the surface treatment at a higher temperature than conventionally employed, as described hereinbefore, the amount can approach more closely the theoretical maximum and the amount of undesirable unreacted (physisorbed) surface treatment agent remaining can thereby be advantageously and unexpectedly minimised.

Desirably, as described in WO-A-99/28050, the concentration of surface treatment agent present in the atmosphere in which the particulate material is to be surface treated by the agent is not substantially greater than X % by weight based on the weight of particulate material, where X is given by
X=T+U (2)
where T is the theoretical amount of the agent required to cover the surface area of the particulate material and U is the amount of unreacted surface treatment agent (% by weight based on the dry weight of the particulate material) obtained when the particulate material is in fact treated by the agent under the treatment conditions employed (this may be determined from a previous treatment run under the same conditions). Desirably, the concentration of the applied surface treatment agent is between about 0.8 X and about 1.0 X.

It has been shown and described in WO-A-99/28050 that a suitable amount of surface treatment agent is that required to coat or slightly undercoat or not substantially overcoat the carbonate. The amount required depends on the surface treatment agent employed, as explained earlier. For an agent containing at least 60% by weight stearic acid, for example, the amount is preferably in the range of from 2.0% about to 3.0% about based on the dry weight of the carbonate.

The carbonate may be dried to a total surface moisture level not exceeding 0.3 wt %, preferably not exceeding 0.25 wt %, and preferably less than 0.2 wt %, based on the dry weight of the carbonate. Preferably, the surface moisture level is within these specified limits both immediately preceding and following the hydrophobic surface coating. As specified above, the surface moisture level of the carbonate is measured by weight loss after drying in an oven at 110° C. to constant weight.

The natural carbonate of the invention may be used as a filler and for example may be incorporated in moisture-curing polymer composition together with a moisture-curing polymer material and other optional conventional additives. Examples of such optional additives are: pigments, rheological additives, thixotropes, extenders, organic thixotropes such as waxes, plasticizers, uv stabilizers, silanes, adhesion promoters and dehydrating agents. The carbonate of the invention may also be used as a filler in other polymer systems where moisture is detrimental to the polymerization process, such as tow part polyurethane systems where the presence of moisture may cause premature curing of the isocyanate component.

To the extent that the natural carbonate of the invention may have picked up minor amounts of moisture during storage, it may be desirable to carry out a drying operation on the carbonate immediately prior to incorporation in the polymer composition, in order to reduce the moisture level to a desired level which is appropriate to the moisture-curing polymer application (or other polymer application where moisture is detrimental) intended. Such drying may be accomplished by heating the carbonate to drive off moisture or may be a chemical drying technique using, for example, a chemical drying agent such as a silane or CaO.

A wide variety of moisture-curable polymer compositions are known, and the carbonate of the present invention is suitable for use in any such composition. One group of moisture-curing polymers in which the natural carbonate of the present invention may be used are those which include silane groups, such as polyurethanes provided with terminal silane groups, polyether polymers with terminal silane groups and polysulfide polymers with terminal silane groups. The natural carbonate may also be used with PVC based polymers.

The polymer composition may be for example a SPUR sealant composition or an MS sealant composition.

The carbonate of the invention may be used as filler in two part polyurethane systems, and is suited for use as a filler in the isocyanate component of such systems which are apt to cure prematurely in the presence of moisture. Such two component polyurethane systems are, for example, available from H.B. Fuller

The polymer compositions incorporating the natural carbonate of the invention typically will contain at least 20 wt %, preferably up to 75 wt % of the carbonate, more preferably 40 to 70 wt %, based on the total weight of the composition and are typically made by a process in which the basic polymer resin, such as moisture-curing polymer composition is compounded with the carbonate material and other optional additives, and then sealed in a suitable receptacle from which it may be dispensed for use. A typical process for making a fully formulated sealant or like composition will be as follows:
(a) combine the polymer resin and a plasiticizer and mix to form a homogenous blend;
(b) add the natural carbonate of the invention and other additives, such as thixotropes, pigments and stabilizers;
(c) if necessary raise temperature to dry to desired moisture content.
(d) add silanes; and
(e) disperse silanes and other additives in the composition.

### DESCRIPTION OF ILLUSTRATIVE EMBODIMENTS

Embodiments of the present invention will now be described by way of example only with reference to the following Examples.

### EXAMPLE 1

A marble feed having less than 10% by weight of particles greater than 53 μm and less than 10% by weight of particles smaller than 2 μm was ground at a varying solids content of between 40% and 14% (dispersant free). Grinding was in the presence of a grinding medium.

The resulting product was centrifuged to about 44% solids content. The centrifuged product, together with some already dried product, was then dried and milled resulting in a powder with a moisture content below 0.3 wt %. The dried ground calcium carbonate was coated using 2.75% stearic acid.

The ground calcium carbonate of this example had the following particle size distribution by Sedigraph:
99% smaller than 2 μm
95% smaller than 1 μm
69% smaller than 0.5 μm
30% smaller than 0.25 μm
8% smaller than 0.1 μm
d₅₀₌0.36 μm

The surface area (by BET nitrogen adsorption) was 12.6 m²/g. The moisture pick up was measured by first drying the ground carbonate to dryness (at 110° C.) and then exposing it to an atmosphere of 80% relative humidity for 7 days at a temperature of 20° C. Using this procedure, the amount of moisture adsorbed (the moisture pick up) was 1600 ppm by weight (that is 0.16 wt %).

### EXAMPLE 2

A sample of calcium carbonate was prepared by dry grinding using a vertical ball mill and coating with 3 wt % stearic acid as in Example 1. The d₅₀ was determined to be 0.38 μm and the surface area was less than 14 m²/g. Moisture pick up was determined using the same method as Example 1 to be 1400 ppm by weight (that is 0.14 wt %).

### EXAMPLE 3

The same marble feed of Example 1 was ground at low solids (less than 20 wt %) in the absence of dispersant at pilot scale. The grinder product was dewatered, dried and milled at a pilot scale and coated using 3% stearic acid. The d₅₀ was determined to be 0.34 μm and the surface area was 11 m²/g. Moisture pick up was determined using the same method as Example 1 to be 1000 ppm by weight (that is 0.10 wt %).

### EXAMPLE 4

The course fraction of the grinder product of Example 3 was fractionated using a decanting centrifuge, dewatered, dried and milled, and coated by the general procedure set forth in Example 1, but with 3% stearic acid. The d₅₀ was determined to be 0.4 μm and the surface area was 7.2 m²/g. Moisture pick up was determined using the same method as Example 1 to be 1100 ppm by weight (that is 0.11 wt %).

### EXAMPLE 5 (COMPARATIVE)

The same marble feed of Example 1 was ground at high solids in the presence of dispersant. The product was dried, milled and coated by the general procedure of Example 1, but with 3% stearic acid. The d₅₀ was determined to be 0.45 μm and the surface area was 13.4 m²/g. Moisture pick up was determined using the same method as Example 1 to be 6000 ppm by weight (that is 0.6 wt %).

### EXAMPLE 6

A SPUR sealant composition was prepared using the dried ground and coated calcium carbonate of Example 3 in accordance with the following formulation (Table 1)

TABLE 1

| Component A | |
|---|---|
| Polymer | 36.30 |
| Plasticizer | 12.80 |
| ground carbonate | 46.28 |
| Component B | |
| Fumed silica | 1.50 |
| Component C | |
| Moisture scavenger | 0.10 |
| Component D | |
| Moisture scavenger | 0.75 |
| Adhesion promoter | 2.00 |
| Stabiliser | 0.25 |
| Component E | |
| Catalyst | 0.02 |
| Total | 100.00 |

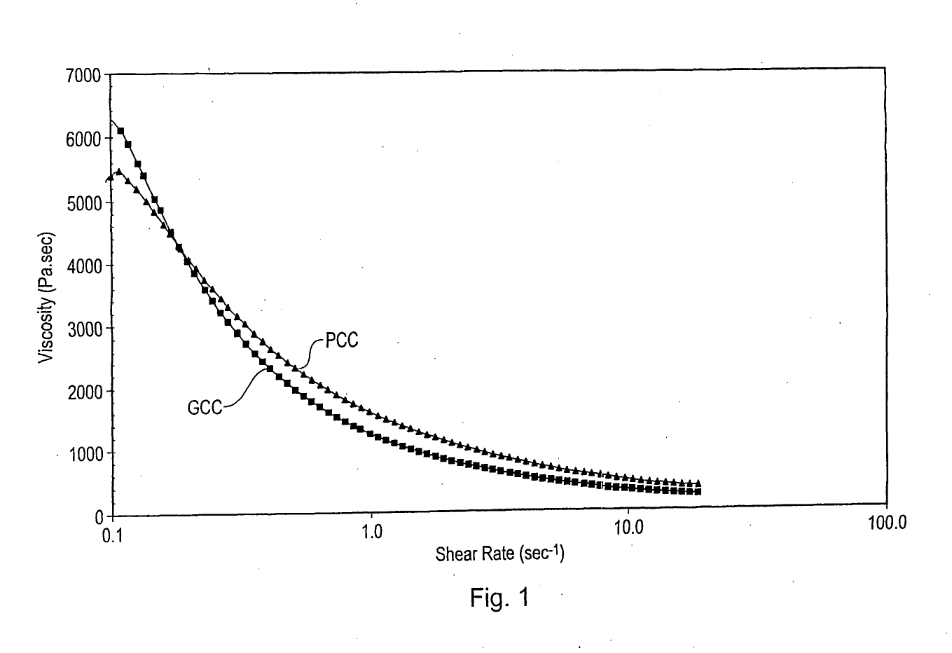

By way of comparison, a fine stearate coated PCC (d₅₀ of 0.07 μm and surface area of 22-26 m²/g) sold commercially as a filler for sealant compositions was made into a sealant composition using the same formulation, but substituting the PCC for the ground calcium carbonate. The viscosity properties of the two sealant compositions were then determined and are displayed in FIG. 1. The ground calcium carbonate of the invention provides comparable properties to the commercially available fine PCC.

TABLE 2

| | PCC | GCC |
|---|---|---|
| Hardness (Shore A) | 45.6 | 40.3 |
| Tensile (Mpa) | 1.53 | 1.08 |
| Elongation (%) | 146 | 186 |
| 50% Modulus (Mpa) | 0.85 | 0.63 |
| 100% Modulus (Mpa) | 1.36 | 0.91 |
| L* | 92.9 | 89.9 |
| a* | −0.1 | 0.5 |
| b* | 2.8 | 5.8 |

### EXAMPLE 7

MS sealant compositions were prepared using the dried, ground and coated calcium carbonate of Example 3 and a commercially available stearate coated PCC having a d₅₀ of 0.07 μm in accordance with the following formulation (Table 3):

TABLE 3

| Component A | | |
|---|---|---|
| PCC | 42 | 0 |
| GCC | 0 | 47.2 |
| TiO₂ | 3.5 | 3.2 |
| Component B | | |
| Liquid fraction | 48.5 | 44.1 |
| containing MS Polymer | | |
| Component C | | |
| Additives | 4 | 3.8 |
| Component D | | |
| Silanes and catalyst | 2 | 1.7 |

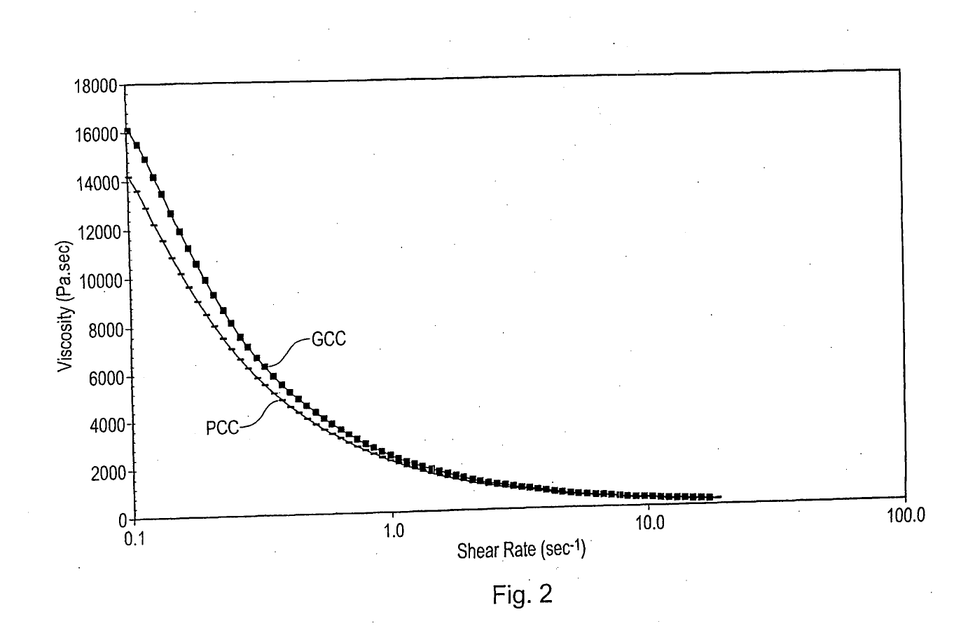

The viscosity properties of the two sealant compositions were then determined and are displayed in FIG. 2. The ground calcium carbonate of the invention provides comparable properties to the commercially available fine PCC.

The content of each of the documents cited herein is incorporated by reference in its entirety for all purposes.

1-40. (canceled)

41. A natural alkaline earth metal carbonate in particulate form having a d₅₀ of about 0.5 μm or less and a moisture pick up of less than about 0.2 wt %.

42. The alkaline earth metal carbonate of claim 41, having a surface moisture content less than about 0.25 wt % based on the dry weight of the carbonate.

43. The alkaline earth metal carbonate of claim 42, having a surface moisture content less than about 0.20 wt % based on the dry weight of the carbonate.

44. The alkaline earth metal carbonate of claim 41, wherein the particles of the carbonate have been treated with a hydrophobizing agent.

45. The alkaline earth metal carbonate of claim 44, wherein the hydrophobising agent is an aliphatic carboxylic acid having from about 10 to about 24 carbon atoms in the chain.

46. The alkaline earth metal carbonate of claim 45, wherein the hydrophobising agent is selected from stearic acid, palmitic acid, montanic acid, capric acid, lauric acid, myristic acid, isostearic acid, cerotic acid, and mixtures thereof.

47. The alkaline earth metal carbonate of claim 44, having a surface moisture content less than about 0.25 wt % based on the dry weight of the carbonate.

48. The alkaline earth metal carbonate of claim 41, wherein the d₅₀ is at least about 0.2 μm.

49. The alkaline earth metal carbonate of claim 48, wherein the d₅₀ is about 0.4 μm or less.

50. The alkaline earth metal carbonate of claim 49, wherein the d₅₀ is about 0.4 μm.

51. The alkaline earth metal carbonate of claim 41, wherein the carbonate has a surface area of less than about 14 m²/g as measured by the BET nitrogen method.

52. The alkaline earth metal carbonate of claim 51, wherein the BET nitrogen surface area is at least about 10 m²/g.

53. The alkaline earth metal carbonate of claim 52, wherein the BET nitrogen surface area is about 12 m²/g.

54. The alkaline earth metal carbonate of claim 41, obtained by grinding a natural source of calcium carbonate, magnesium carbonate, calcium magnesium carbonate, or barium carbonate.

55. The alkaline earth metal carbonate of claim 54, obtained by grinding a natural source of calcium carbonate selected from chalk, limestone, and dolomite.

56. The alkaline earth metal carbonate of claim 41, obtained by grinding marble.

57. The alkaline earth metal carbonate of claim 54, wherein the carbonate is essentially free of hygroscopic and hydrophilic chemicals.

58. A process for making a particulate alkaline earth metal carbonate, comprising grinding a natural source of alkaline earth metal carbonate under conditions to produce a particulate material having a d₅₀ of about 0.5 μm or less and a surface area of less than about 14 m²/g as measured by the BET nitrogen method.

59. The process according to claim 58, wherein the natural source of alkaline earth metal carbonate is dry ground.

60. The process according to claim 58, wherein the natural source of alkaline earth metal carbonate is wet ground.

61. The process according to claim 60, wherein the amount of water soluble hydrophilic dispersant remaining following grinding is not greater than about 0.05% by dry weight of carbonate.

62. The process according to claim 58, wherein the particulate material is dried to a state such that not more than about 0.25 wt % surface moisture content remains associated with the material.

63. The process according to claim 58, wherein the particulate alkaline earth metal carbonate is treated with a hydrophobising agent, the resulting treated carbonate having a surface moisture content of no more than about 0.25 wt %.

64. A process for making a particulate alkaline earth metal carbonate, comprising processing a natural source of alkaline earth metal carbonate under conditions including grinding conditions to produce a particulate material having a d₅₀ of about 0.5 μm or less and a moisture pick up of less than about 0.2 wt %.

65. The process according to claim 64, wherein the natural source of alkaline earth metal carbonate is dry ground.

66. The process according to claim 64, wherein the natural source of alkaline earth metal carbonate is wet ground.

67. The process according to claim 66, wherein the amount of water soluble hydrophilic dispersant remaining following grinding is not greater than about 0.05% by dry weight of carbonate.

68. The process according to claim 64, wherein the particulate material is dried to a state such that not more than about 0.25 wt % surface moisture content remains associated with the material.

69. The process according to claim 64, wherein the particulate alkaline earth metal carbonate is treated with a hydrophobising agent, the resulting treated carbonate having a surface moisture content of no more than about 0.25 wt %.

70. The process according to claim 64, wherein the particulate material has a surface area of less than about 14 m²/g as measured by the BET nitrogen method.

71. A polymer composition comprising a polymer material and a natural alkaline earth metal carbonate as claimed in claim 41.

72. The polymer composition according to claim 71, wherein the polymer composition is a moisture-curing polymer composition.

73. The polymer composition according to claim 72, wherein the moisture-curing polymer comprises silane groups.

74. The polymer composition according to claim 73, wherein the moisture-curing polymer is selected from polyurethanes provided with terminal silane groups, polyether polymers with terminal silane groups, and polysulfide polymers with terminal silane groups.

75. The polymer composition according to claim 71, wherein the polymer composition is a two-component polyurethane system.

76. The polymer composition according to claim 71, wherein the composition comprises at least about 25% of the natural alkaline earth metal carbonate based on the total weight of the composition.

77. The polymer composition according to claim 71, wherein the composition comprises up to about 75% of the natural alkaline earth metal carbonate based on the total weight of the composition.

78. The polymer composition according to claim 71, wherein the composition comprises from about 40 to about 70 wt % of the natural alkaline earth metal carbonate based on the total weight of the composition.

79. The polymer composition of claim 71, wherein the composition is a sealant, a mastic, a coating, an adhesive, a plastisol or a rubber.

80. A cured element obtained by curing the polymer composition of claim 71.
